(19) United States
(12) Patent Application Publication
(10) Pub. No.: US 2013/0055254 A1
(43) Pub. Date: Feb. 28, 2013

(54) METHODS AND APPARATUSES FOR PROVIDING A VIRTUAL MACHINE WITH DYNAMIC ASSIGNMENT OF A PHYSICAL HARDWARE RESOURCE

(71) Applicants: Adhyas Avasthi, Fremont, CA (US); Sreekumar Ramakrishnan Nair, San Jose, CA (US); Weidong Shi, Pearland, TX (US); Timothy Youngjin Sohn, Mountain View, CA (US); Cynthia Kuo, Mountain View, CA (US); Rachel Beth Hinman, Mountain View, CA (US); Quinn Able Jacobson, Sunnyvale, CA (US)

(72) Inventors: Adhyas Avasthi, Fremont, CA (US); Sreekumar Ramakrishnan Nair, San Jose, CA (US); Weidong Shi, Pearland, TX (US); Timothy Youngjin Sohn, Mountain View, CA (US); Cynthia Kuo, Mountain View, CA (US); Rachel Beth Hinman, Mountain View, CA (US); Quinn Able Jacobson, Sunnyvale, CA (US)

(73) Assignee: NOKIA CORPORATION, Espoo (FI)

(21) Appl. No.: 13/222,656

(22) Filed: Aug. 31, 2011

(51) Int. Cl. G06F 9/50; G06F 9/455

(52) U.S. Cl. 718/1

(57) ABSTRACT

Methods and apparatuses are provided for providing a virtual machine with dynamic direct assignment of a physical hardware resource. A method may include providing a virtual machine with a directly assigned physical hardware resource and an emulated hardware resource corresponding to the directly assigned physical hardware resource. The method may further include causing the virtual machine to hot-swap from using the directly assigned physical hardware resource to using the emulated hardware resource. The method may additionally include, subsequent to causing the virtual machine to hot-swap to using the emulated hardware resource, causing the directly assigned physical hardware resource to be hot-removed from the virtual machine Corresponding apparatuses are also provided.

### TECHNOLOGICAL FIELD

Example embodiments of the present invention relate generally to computing technology and, more particularly, relate to methods and apparatuses for providing a virtual machine with dynamic assignment of a physical hardware resource.

### BACKGROUND

The modern computing era has brought about a tremendous expansion in computing power resulting in a reduction in the size of computing devices, as well as a significant reduction in the cost per unit of computing power. Today's mobile devices are even capable of performing functionality that only a few years ago required processing power provided only by the most advanced desktop computers. Consequently, computing devices, such as mobile computing devices, having a relatively small form factor have become ubiquitous and are used to access network applications and services by consumers of all socioeconomic backgrounds.

In spite of this expansion in computing power and increasing ubiquity of computing devices, there is still an unsatisfied demand for additional computing resources. One solution that is being used to attempt to satisfy the demand for additional computing resources is leveraging the power of modern computing hardware to implement virtual machines on an underlying physical machine. In this regard, a virtual machine may comprise an emulated machine running in software on top of an underlying physical machine. The virtual machine may provide its own execution platform, which may appear to be an independent physical computing platform to a user. A single physical machine may accordingly run multiple virtual machines, which may share a single file system, and which may share underlying hardware resources. Further, a given virtual machine may behave as if it owns the underlying physical machine and need not be aware that it is executing with another virtual machine(s) on the same physical machine. As such, virtual machines may be leveraged to enable a single physical machine to provide computing platforms for multiple users, emulate multiple computing environments, and/or the like.

### BRIEF SUMMARY

Methods, apparatuses, and computer program products are herein provided for providing a virtual machine with dynamic assignment of a physical hardware resource. Methods, apparatuses, and computer program products in accordance with various embodiments may provide several advantages to computing devices, computing device users, hardware developers, and application developers. Some example embodiments provide for dynamic direct assignment of a physical hardware resource to a virtual machine, allowing the virtual machine with access to a physical hardware resource that may provide greater performance than a corresponding emulated hardware resource. Further, some such example embodiments, provide for direct assignment (e.g., dynamic assignment) of a physical hardware resource to a virtual machine while still enabling the virtual machine to be migrated from a first physical machine to a second physical machine, thus providing for more flexibility and control over a virtual machine.

Additionally, some example embodiments that provide direct assignment of a physical hardware resource allow hot-removal and hot-assignment of the physical hardware resource from/to a virtual machine. Accordingly, a physical hardware resource may be dynamically assigned to and removed from a virtual machine on an as-needed basis without requiring re-booting of the virtual machine. This feature may provide performance enhancements to multiple virtual machines running on an underlying physical machine without incurring the cost of duplication of a physical hardware resource needed. In this regard, a single physical hardware resource may be rotated among a plurality of virtual machines on an as-needed basis, priority basis, and/or the like without requiring direct assignment of the physical hardware resource to a single virtual machine for the duration of the execution of the virtual machine in a manner in which the physical hardware resource is unavailable for use by other virtual machines.

In a first example embodiment, a method is provided, which may comprise providing a virtual machine with a directly assigned physical hardware resource. The directly assigned physical hardware resource of this example embodiment may be used by the virtual machine. The method of this example embodiment may further comprise providing the virtual machine with an emulated hardware resource corresponding to the directly assigned physical hardware resource. The emulated hardware resource of this example embodiment may not be in use while the directly assigned physical hardware resource is being used by the virtual machine. The method of this example embodiment may additionally comprise causing the virtual machine to hot-swap from using the directly assigned physical hardware resource to using the emulated hardware resource. The method of this example embodiment may also comprise, subsequent to causing the virtual machine to hot-swap to using the emulated hardware resource, causing the directly assigned physical hardware resource to be hot-removed from the virtual machine.

In another example embodiment, an apparatus comprising at least one processor and at least one memory storing computer program code is provided. The at least one memory and stored computer program code may be configured, with the at least one processor, to cause the apparatus of this example embodiment to at least perform providing a virtual machine with a directly assigned physical hardware resource. The directly assigned physical hardware resource of this example embodiment may be used by the virtual machine. The at least one memory and stored computer program code may be configured, with the at least one processor, to cause the apparatus of this example embodiment to further perform providing the virtual machine with an emulated hardware resource corresponding to the directly assigned physical hardware resource. The emulated hardware resource of this example embodiment may not be in use while the directly assigned physical hardware resource is being used by the virtual machine. The at least one memory and stored computer program code may be configured, with the at least one processor, to cause the apparatus of this example embodiment to additionally perform causing the virtual machine to hot-swap from using the directly assigned physical hardware resource to using the emulated hardware resource. The at least one memory and stored computer program code may be configured, with the at least one processor, to cause the apparatus of this example embodiment to also perform, subsequent to causing the virtual machine to hot-swap to using the emulated hardware resource, causing the directly assigned physical hardware resource to be hot-removed from the virtual machine.

In another example embodiment, a computer program product is provided. The computer program product of this example embodiment includes at least one computer-readable storage medium having computer-readable program instructions stored therein. The program instructions of this example embodiment may comprise program instructions configured to cause an apparatus to perform a method. The method of this example embodiment may comprise providing a virtual machine with a directly assigned physical hardware resource. The directly assigned physical hardware resource of this example embodiment may be used by the virtual machine. The method of this example embodiment may further comprise providing the virtual machine with an emulated hardware resource corresponding to the directly assigned physical hardware resource. The emulated hardware resource of this example embodiment may not be in use while the directly assigned physical hardware resource is being used by the virtual machine. The method of this example embodiment may additionally comprise causing the virtual machine to hot-swap from using the directly assigned physical hardware resource to using the emulated hardware resource. The method of this example embodiment may also comprise, subsequent to causing the virtual machine to hot-swap to using the emulated hardware resource, causing the directly assigned physical hardware resource to be hot-removed from the virtual machine.

In another example embodiment, an apparatus is provided that may comprise means for providing a virtual machine with a directly assigned physical hardware resource. The directly assigned physical hardware resource of this example embodiment may be used by the virtual machine. The apparatus of this example embodiment may further comprise means for providing the virtual machine with an emulated hardware resource corresponding to the directly assigned physical hardware resource. The emulated hardware resource of this example embodiment may not be in use while the directly assigned physical hardware resource is being used by the virtual machine. The apparatus of this example embodiment may additionally comprise means for causing the virtual machine to hot-swap from using the directly assigned physical hardware resource to using the emulated hardware resource. The apparatus of this example embodiment may also comprise means for, subsequent to causing the virtual machine to hot-swap to using the emulated hardware resource, causing the directly assigned physical hardware resource to be hot-removed from the virtual machine.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus for providing a virtual machine with dynamic direct assignment of a physical hardware resource according to some example embodiments;

FIG. 2 is a schematic block diagram of a mobile terminal according to some example embodiments;

FIG. 3 illustrates a schematic example of a hot-add of a physical hardware resource according to some example embodiments;

FIG. 4 illustrates a schematic example of a hot-swap according to some example embodiments;

FIG. 5 illustrates a schematic example of a hot-remove of a physical hardware resource according to some example embodiments;

FIG. 6 illustrates an example process flow according to an example hot-add and hot-swap of a physical graphics controller according to some example embodiments;

FIG. 7 illustrates an example process flow according to an example live migration of a virtual machine having a directly assigned physical graphics controller according to some example embodiments; and

FIG. 8 illustrates a flowchart according to an example method for providing a virtual machine with dynamic direct assignment of a physical hardware resource according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Virtualization is a technology enabling multiple emulated virtual machines to be run on a single physical machine in a manner that each virtual machine instance behaves as if it owns the physical machine and need not be aware that it is executing with other virtual machine software on the same physical machine. Accordingly, available hardware resources on the physical machine may need to be either duplicated or emulated to satisfy the resource requirements by each virtual machine. Duplication and emulation represent two extremes of performance and consolidation, respectively. In this regard, duplication of hardware resources on a physical machine to provide multiple instances of a physical hardware resource such that each respective instance of the physical hardware resource may be assigned to a respective virtual machine instance may provide greater performance. However, the cost of duplication of physical hardware resources both in terms of monetary cost and in terms of physical space/expansion slot costs may be quite burdensome. Emulation enables multiple instances of a hardware resource to be emulated on a single physical machine such that an emulated hardware resource may be assigned to each virtual machine at a relatively low cost without requiring additional hardware. However, emulated hardware resources often do not offer the same performance level as corresponding physical hardware resources.

As an example, graphics performance may be a bottleneck for virtualization. Since Graphics hardware is costly, it may often not be cost effective to duplicate it in a physical machine. As some applications require a high performance three-dimensional (3D) graphics device, emulation is often not very effective in providing a sufficient level of performance in a virtual machine setup. Graphics pass-through, in which a physical graphics controller is directly assigned to a virtual machine, is one alternative configuration, but the problem with this approach is that it ties the virtual machine to the physical machine comprising the directly assigned graphical controller. One of the benefits of virtualization is live migration, or the ability to move a running virtual machine from one physical machine to another without needing to reboot the virtual machine. Direct assignment accordingly tends to block such live migration, which accordingly may limit the potential for usage of virtual machines and may mitigate advantages that may otherwise be obtained from the sue of virtual machines.

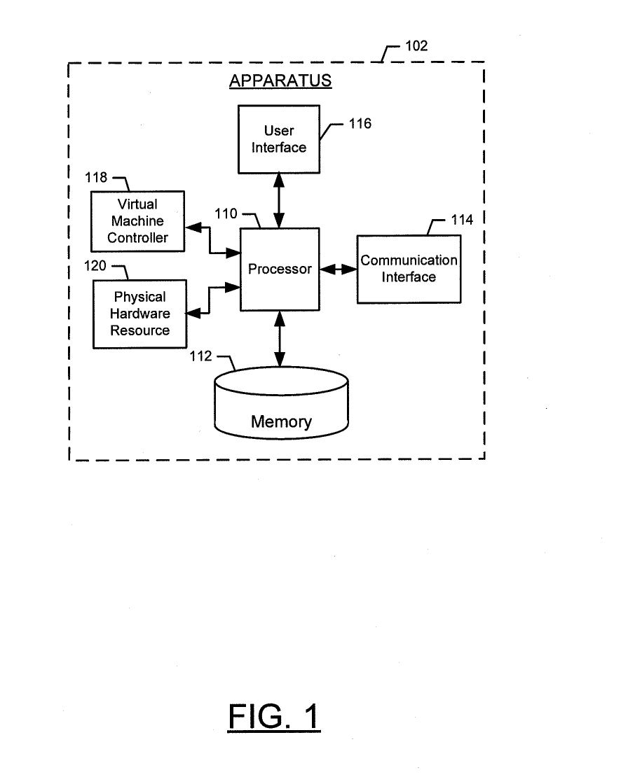

Some example embodiments enable live migration of virtual machines that have direct assignment of physical hardware resources. As such, some such example embodiments may extend the benefits of virtual machine implementations to contexts requiring access to higher performance direct pass-through hardware resources, such as applications requiring direct assignment of 3D graphics controllers. Referring now to FIG. 1, FIG. 1 illustrates a block diagram of an apparatus 102 for providing a virtual machine with dynamic direct assignment of a physical hardware resource according to some example embodiments. It will be appreciated that the apparatus 102 is provided as an example of some embodiments and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for providing a virtual machine with dynamic direct assignment of a physical hardware resource, other configurations may also be used to implement embodiments of the present invention.

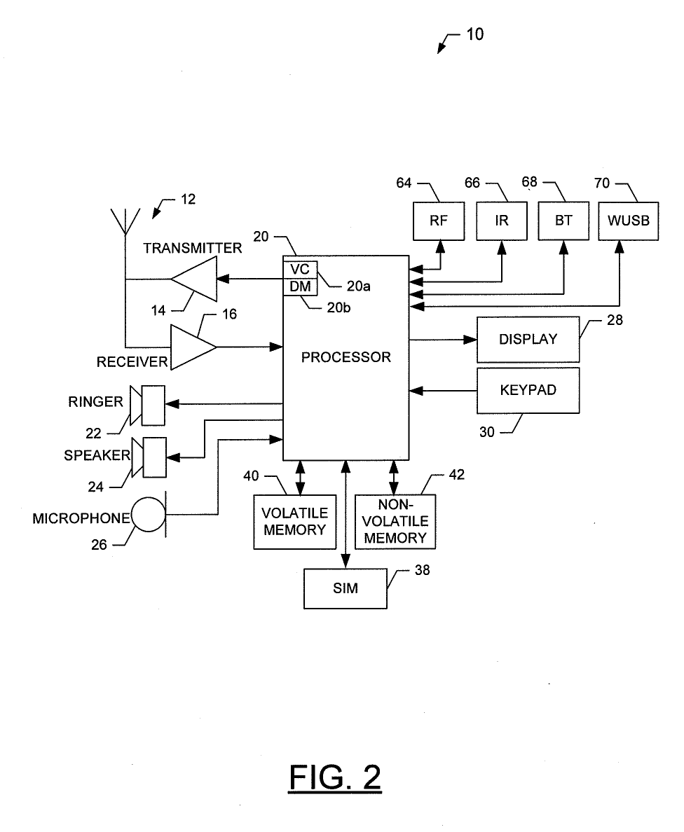

The apparatus 102 may be embodied as one or more servers, a server cluster, a cloud computing infrastructure, one or more desktop computers, one or more laptop computers, one or more network nodes, multiple computing devices in communication with each other, a mobile terminal, mobile computer, mobile phone, mobile communication device, game device, digital camera/camcorder, audio/video player, television device, digital video recorder, positioning device, game controller, television controller, electronic device controller, chipset, a computing device comprising a chipset, any combination thereof, and/or the like. In this regard, the apparatus 102 may comprise any computing device or plurality of computing devices that is configured to provide a physical machine on which one or more virtual machines may be implemented according or more example embodiments disclosed herein. In this regard, the apparatus 102 may comprise an apparatus including one or more physical hardware resources that may be directly assigned to a virtual machine in accordance with one or more example embodiments. In some example embodiments, the apparatus 102 is embodied as a mobile computing device, such as the mobile terminal illustrated in FIG. 2.

In this regard, FIG. 2 illustrates a block diagram of a mobile terminal 10 representative of some example embodiments of an apparatus 102. It should be understood, however, that the mobile terminal 10 illustrated and hereinafter described is merely illustrative of one type of apparatus 102 that may implement and/or benefit from various embodiments of the invention and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), future communication, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the interne or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. One or more of the volatile memory 40 or non-volatile memory 42 may be embodied as a tangible, non-transitory memory. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in some example embodiments, the apparatus 102 includes various means for performing the various functions herein described. These means may comprise one or more of a processor 110, memory 112, communication interface 114, user interface 116, virtual machine controller 118, or physical hardware resource 120. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, user interface 116, virtual machine controller 118, and/or physical hardware resource 120 may be at least partially embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 1 as a single processor, in some example embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to one or more example embodiments while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42. The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, a pre-stored set of template gestures. This stored information may be stored and/or used by the virtual machine controller 118 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. By way of example, the communication interface 114 may be configured to receive data from and/or transmit data to another apparatus (e.g., another apparatus 102) over a network to facilitate migration of a virtual machine from/to the another apparatus. The communication interface 114 may additionally be in communication with the memory 112, user interface 116, virtual machine controller 118, and/or physical hardware resource 120, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In some example embodiments, such as some example embodiments wherein the apparatus 102 is embodied on one or more servers, aspects of the user interface 116 may be more limited, or the user interface 116 may even be removed entirely. The user interface 116 may be in communication with the memory 112, communication interface 114, virtual machine controller 118, and/or physical hardware resource 120, such as via a bus.

The virtual machine controller 118 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In embodiments wherein the virtual machine controller 118 is embodied separately from the processor 110, the virtual machine controller 118 may be in communication with the processor 110. The virtual machine controller 118 may further be in communication with one or more of the memory 112, communication interface 114, user interface 116, or physical hardware resource 120, such as via a bus.

The apparatus 102 may additionally comprise one or more physical hardware resources 120. A physical hardware resource 120 may comprise any physical hardware resource which may be implemented on the apparatus 102, and which may be directly assigned to a virtual machine, such as a virtual machine running on the apparatus 102. By way of example, a physical hardware resource 120 may comprise a physical graphics controller, such as a physical graphics card, physical graphics device, or the like. As another example, a physical hardware resource 120 may comprise a physical network controller, such as a physical network interface card, a physical network device, or the like. As still a further example, a physical hardware resource 120 may comprise a physical storage controller. It will be appreciated, however, that a physical graphics controller, physical network controller, and physical storage controller are provided only by way of example of some embodiments of a physical hardware resource 120, and not by way of limitation.

In some example embodiments, the virtual machine controller 118 may be configured to control one or more virtual machines that may run on the apparatus 102. In this regard, the virtual machine controller 118 may control execution of a virtual machine(s) on one or more physical machine platforms that may be provided by the apparatus 102 in accordance with some example embodiments. In some example embodiments, the virtual machine controller 118 may be configured to directly assign a physical hardware resource 120 to a virtual machine. Further, in some example embodiments, the virtual machine controller 118 may be configured to cause a virtual machine to be migrated from a first physical machine to a second physical machine. For example, the virtual machine controller 118 may be configured to cause migration of a virtual machine from/to a first physical machine that may be provided by the apparatus 102 to a second physical machine that may be provided by the apparatus 102. Additionally or alternatively, the virtual machine controller 118 may be configured to cause migration of a virtual machine from/to the apparatus 102 to/from another apparatus, such as another apparatus 102, which may be in communication with the apparatus 102 via the communication interface 114.

As will be described further herein below, in some example embodiments, the virtual machine controller 118 may be configured to support live migration of a virtual machine having a directly assigned physical hardware resource by additionally providing the virtual machine with an emulated hardware resource corresponding to the directly assigned physical hardware resource. For example, if a virtual machine is provided with a directly assigned graphics controller, the virtual machine may also be provided with an emulated graphics controller. Accordingly, the virtual machine may see two graphics controllers—an emulated (potentially slower performance) graphics controller, and a directly assigned physical graphics controller. As will be further described, in accordance with some example embodiments, the virtual machine controller 118 may be configured to cause the virtual machine to hot-swap (e.g., switch without requiring reboot of the virtual machine) between the directly assigned physical hardware resource and corresponding emulated hardware resource in order to support migration of the virtual machine and/or to support hot-removal of the directly assigned physical hardware resource (e.g., removal of the directly assigned physical hardware resource without requiring reboot of the virtual machine) and assignment of the physical hardware resource to another virtual machine.

In some example embodiments, a virtual machine may be started with an emulated hardware resource, such as an emulated graphics controller. If the virtual machine needs a higher performance hardware resource, such as a higher performance graphics controller, and a physical hardware resource 120 corresponding to the lower performance emulated hardware resource is available (e.g., not directly assigned to another virtual machine), the physical hardware resource 120 may be directly assigned and hot-added to the virtual machine. In this regard, the physical hardware resource 120 may be directly assigned to the virtual machine such that the virtual machine may be provided both with the emulated hardware resource and the corresponding physical hardware resource 120 without requiring the virtual machine to be rebooted.

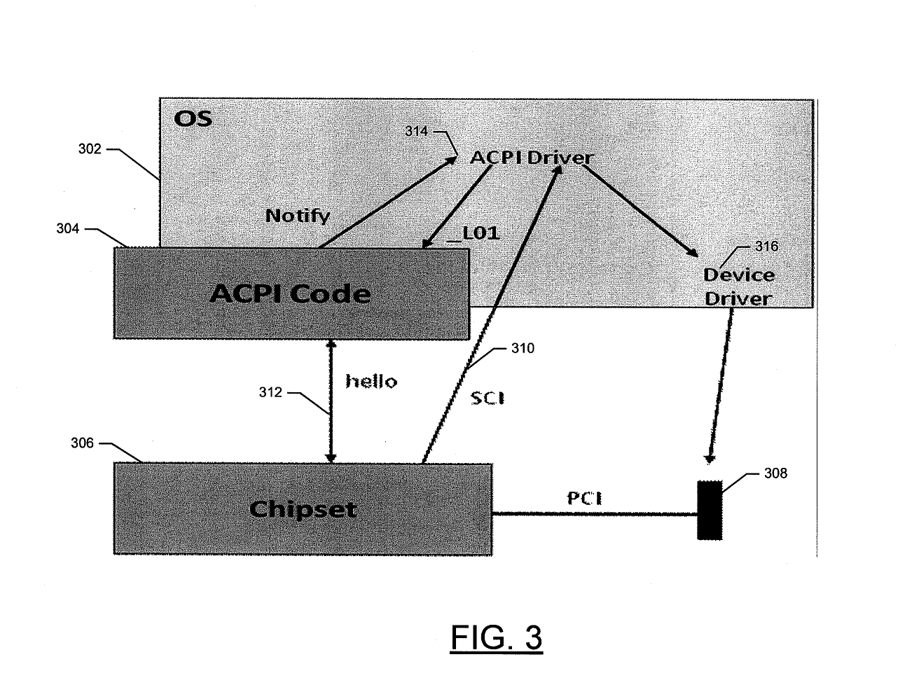

Various techniques may be used by the virtual machine controller 118 to support a hot-add of a physical hardware resource 120. In some example embodiments, the virtual machine controller 118 may control a virtual Advanced Configuration and Power Interface (ACPI) that may be implemented in a virtual Basic Input/Output System (BIOS) of the virtual machine to support a hot-add of a physical hardware resource. In this regard, FIG. 3 illustrates a schematic example of a hot-add of a physical hardware resource according to some example embodiments wherein ACPI is used to support a hot-add of a physical hardware resource 120 to be directly assigned to a virtual machine. In the example of FIG. 3, an operating system (OS) 302 may be run on a virtual machine. ACPI code 304 may be implemented in the OS 302, which may operate under the control of the virtual machine controller 118. The OS 302 and/or ACPI code 304 may be in communication with a chipset 306. The chipset 306 may comprise an emulated physical chipset which may be viewed as hardware by the OS 302. In this regard, the OS 302 may view itself as executing on the chipset 306. In order to initiate the hot-add of the physical hardware resource 308, the virtual machine controller 118 may cause the physical hardware resource 308 to be presented to the virtual machine as being inserted into an interface of the chipset 306, such as a Peripheral Component Interconnect (PCI) slot. In response to the physical hardware resource 308 being virtually inserted in a slot of the chipset 306, a Power Management Interrupt (SCI) 310 may be sent from the chipset 306 to the OS 302. In response to the SCI 310, the ACPI code 304 may interact with the chipset 306 and/or the physical hardware resource 308, as illustrated by operation 312, to determine the type of SCI. Based on the interaction of operation 312, the ACPI code 304 may provide information to the ACPI driver 314 to enable the ACPI driver 314 to load the appropriate device driver 316 for the physical hardware resource 308 and initiate the physical hardware resource 308. The virtual machine may accordingly see two corresponding hardware resources, the first being an emulated hardware resource, and the second being the physical hardware resource 308.

In accordance with some example embodiments, after a physical hardware resource 120 has been hot-added and assigned to a virtual machine, the virtual machine controller 118 may cause the virtual machine to hot-swap from using the emulated hardware resource to using the corresponding physical hardware resource 120. In some example embodiments, the virtual machine controller 118 may be configured to cause the virtual machine to hot-swap from using the emulated hardware resource to the physical hardware resource 120 by way of a virtual ACPI that may be integrated into an operating system of the virtual machine. In this regard, the virtual machine 118 may cause the ACPI to provide a BIOS initiated command to cause an operating system that may be run on a virtual machine to switch to the physical hardware resource 120. After the hot-swap, the virtual machine may start to use the directly assigned physical hardware resource 120, which may provide a higher level of performance than the emulated hardware resource.

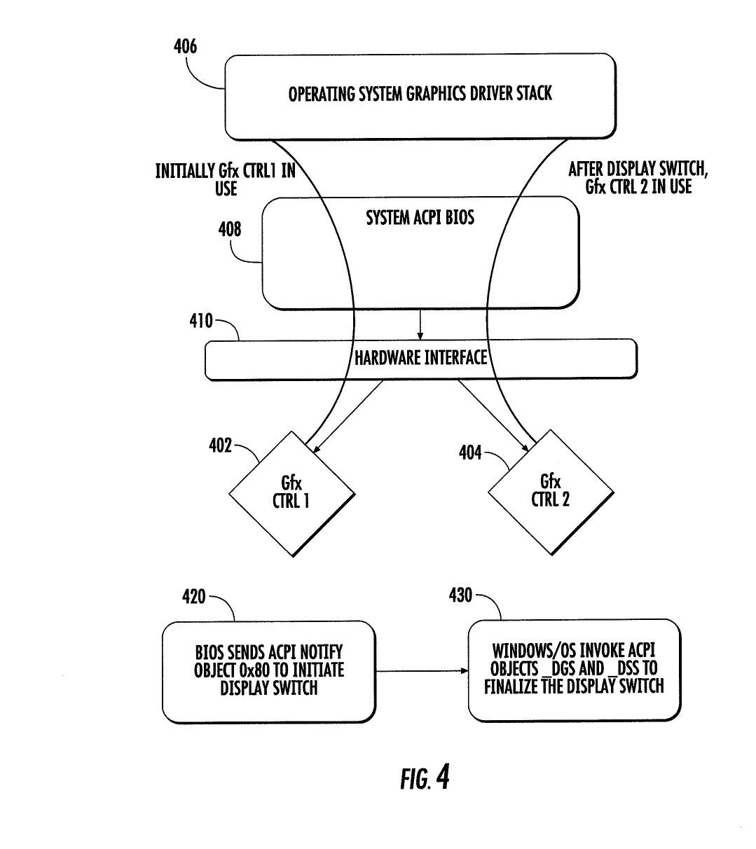

FIG. 4 illustrates a schematic example of a hot-swap according to some example embodiments in which a virtual ACPI may be used to facilitate a hot-swap. In this regard, FIG. 4 illustrates an example in which a virtual machine may be caused to hot-swap from an emulated graphics controller 402 to a directly assigned physical graphics controller 404. Subsequent to a hot-add of the directly assigned physical graphics controller 404, such as in accordance with the example illustrated in FIG. 3, both the emulated graphics controller 402 and the directly assigned physical graphics controller 404 may be visible to the operating system graphics driver stack 406, system ACPI BIOS 408, and hardware interface 410 of the virtual machine. The emulated graphics controller 402 may be in use. Operation 420 may comprise the virtual machine controller 118 causing the ACPI BIOS 408 to initiate a display switch (e.g., a ‘hot-swap’) from the emulated graphics controller 402 to the directly assigned physical graphics controller 404. As an example, the initiation of the display switch may comprise the ACPI BIOS 408 sending an ACPI Notify Object 0x80 to initiate the display switch. Operation 430 may comprise finalization of the display switch. Subsequent to finalization of the display switch, the virtual machine may use the directly assigned physical graphics controller 404 rather than the emulated graphics controller 402. As an example, in some example embodiments wherein a Microsoft Windows® operating system is run on the virtual machine, operation 430 may comprise the virtual machine controller 118 causing the operating system to invoke ACPI objects _DGS and _DSS to finalize the display switch.

In some example embodiments, the virtual machine controller 118 may be further configured to cause the virtual machine to hot-swap back from the directly assigned physical hardware resource 120 to the corresponding emulated hardware resource. The hot-swap may, for example, be performed through the use of ACPI techniques similar to those described in connection with the example illustration of FIG. 4.

A hot-swap back to the emulated hardware resource may, for example, be performed to enable hot-removal of the directly assigned physical hardware resource 120. For example, a hot-swap back to the emulated hardware resource may be performed in response to the virtual machine no longer needing the higher performance that may be offered by the directly assigned physical resource 120. Accordingly, the directly assigned physical resource 120 may be hot-removed and subsequently assigned to another virtual machine. As another example, a hot-swap back to the emulated hardware resource and hot-removal of the directly assigned physical resource 120 may be performed in response to another, higher priority virtual machine needing a directly assigned hardware resource. As yet another example, hot-swap back to the emulated hardware resource and hot-removal of the directly assigned physical resource 120 may be performed to enable live migration of the virtual machine to another physical machine.

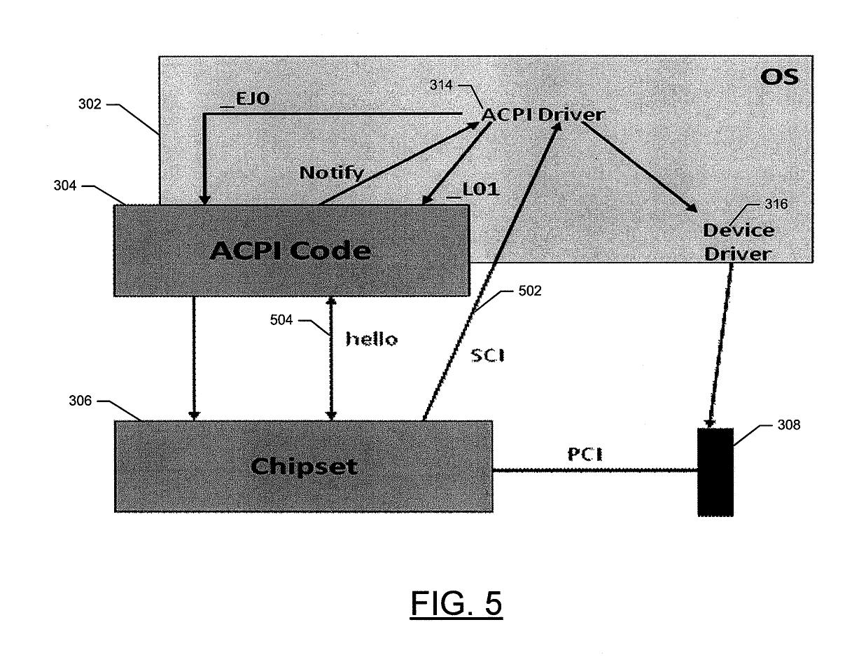

Subsequent to a hot-swap from the directly assigned physical hardware resource 120 back to the corresponding emulated hardware resource, the directly assigned physical hardware resource 120 may be hot-removed from the virtual machine. Various techniques may be used by the virtual machine controller 118 to support a hot-removal of a physical hardware resource 120. In some example embodiments, the virtual machine controller 118 may control a virtual Advanced Configuration and Power Interface (ACPI) that may be implemented in a virtual Basic Input/Output System (BIOS) of the virtual machine to support a hot-removal of a physical hardware resource. In this regard, FIG. 5 illustrates a schematic example of a hot-removal of a physical hardware resource according to some example embodiments wherein ACPI is used to support a hot-add of a physical hardware resource 120 to be directly assigned to a virtual machine. More particularly, FIG. 5 illustrates a hot-removal within the context of the schematic of FIG. 3 subsequent to the example hot-add described with respect to the illustration of FIG. 3.

With reference to FIG. 5, the virtual machine controller 118 may cause a simulated eject request to be sent from the chipset 306 to the ACPI driver 314 of the OS 302, as illustrated by operation 502. The simulated eject request may, for example, comprise an SCI interrupt. In response to the SCI interrupt, the ACPI code 304 may interact with the chipset 306, as illustrated by operation 504, to determine the type of SCI. Based on the interaction of operation 504, the ACPI code 304 may notify the ACPI driver 314 of the SCI interrupt, as illustrated by operation 506. The ACPI driver 314 may, in response to the SCI interrupt, initiate a device ejection sequence, as illustrated by operation 508, to eject the physical hardware resource 308 from the virtual machine (e.g., from the simulated PCI slot of the chipset 306), thus hot-removing the physical hardware resource 308 from the virtual machine. After ejection of the physical hardware resource 308, the OS 302 may confirm the ejection to the ACPI code 304 and/or to the chipset 306.

After a directly assigned physical hardware resource 120 has been hot-removed from a virtual machine, the virtual machine may be live migrated to another physical machine. In this regard, subsequent to hot-removal of any physical hardware resources that may be directly assigned to a virtual machine, the virtual machine may not have any direct pass-through ties to the underlying physical machine, and thus may be migrated to another physical machine. After the virtual machine is migrated, if the virtual machine still needs the higher performance of a directly assigned physical hardware resource, another physical hardware resource (e.g., a physical hardware resource embodied on a physical machine to which the virtual machine has been migrated) may be hot-added to the virtual machine, and a hot-swap from the emulated hardware resource to the physical hardware resource may be performed as previously described.

As such, in accordance with some example embodiments, a virtual machine may be effectively migrated with a directly assigned physical hardware resource. This migration may, for example, be transparent to a user of the virtual machine, as operation of the virtual machine may be seamless during the migration due to hot-swapping from a physical hardware resource to a corresponding emulated hardware resource prior to the migration.

The virtual machine controller 118 may be further configured to control performance as a resource to one or more virtual machines. For example, a performance level may be made available as an administrator selectable configuration parameter for one or more hardware resources. As another level, a priority of multiple types of hardware resources may be ranked in an order of priority for a given virtual machine. The virtual machine controller 118 may accordingly be configured to directly assign a physical hardware resource 120 to a virtual machine or to have the virtual machine use an emulated hardware resource on the basis of priority. As another example, if multiple virtual machines request direct assignment of a physical hardware resource 120, and there are not enough physical hardware resources to satisfy each request, the virtual machine controller 118 may select which virtual machine(s) is directly assigned a physical hardware resource 120 on the basis of respective priorities that may be assigned to the requesting virtual machines. Such assigned priorities may be preemptible, or may be non-preemptible.

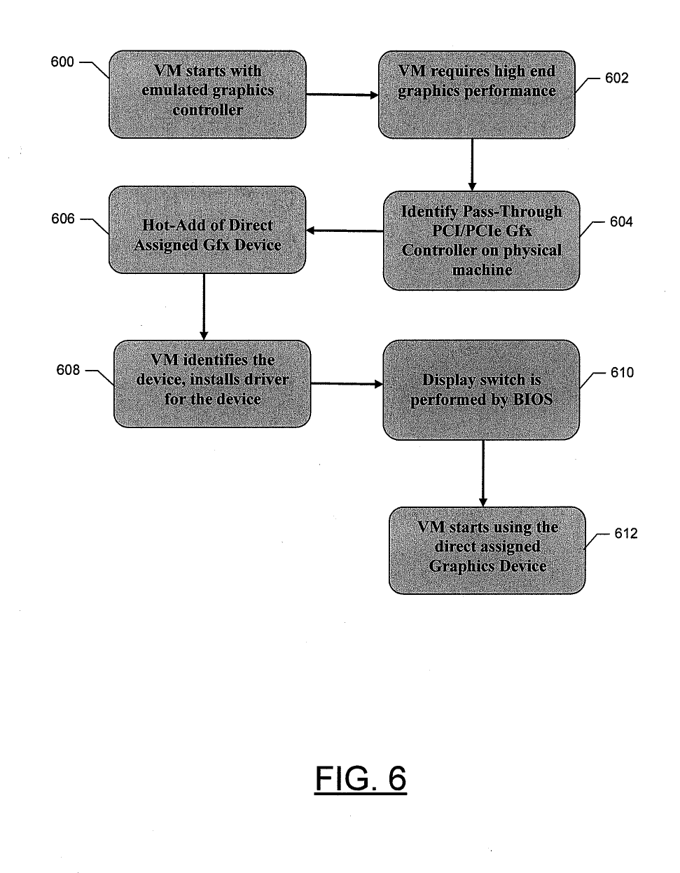

FIG. 6 illustrates an example process flow according to an example hot-add and hot-swap of a physical graphics (Gfx) controller according to some example embodiments. While the example process flow of FIG. 6 is described with respect to a graphics controller, it will be appreciated that the process flow may be applied to other types of physical hardware resources as well. The operations illustrated in and described with respect to FIG. 6 may, for example, be performed by, with the assistance of, and/or under the control of one or more of the processor 110, memory 112, or virtual machine controller 118. Operation 600 may comprise the virtual machine (VM) starting with an emulated graphics controller. At operation 602, the virtual machine may require high end graphics performance beyond a performance level of which the emulated graphics controller is capable. Operation 604 may comprise identifying an available pass-through (e.g., a directly assignable) graphics controller on the underlying physical machine on which the virtual machine is executing. As an example, a pass-through PCI/PCI express (PCIe) graphics controller may be identified. Operation 606 may comprise hot-adding the identified graphics controller to the virtual machine as a directly assigned physical graphics controller. The hot-add of operation 606 may, for example, be performed in accordance with the hot-add operation discussed with respect to FIG. 3. Operation 608 may comprise the virtual machine identifying the directly assigned graphics physical controller and installing a driver for the directly assigned physical graphics controller. Operation 610 may comprise a BIOS of the virtual machine performing a display switch from the emulated graphics controller to the directly assigned physical graphics controller. The display switch of operation 610 may, for example, be performed in accordance with the hot-swap operation discussed with respect to FIG. 4. Operation 612 may comprise the virtual machine starting to use the directly assigned physical graphics controller.

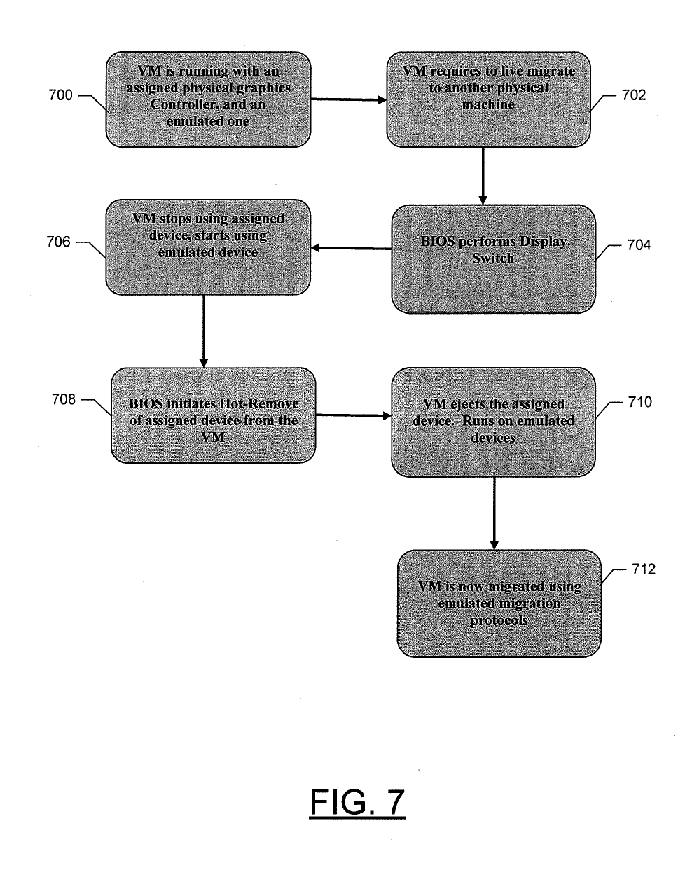

FIG. 7 illustrates a an example process flow according to an example live migration of a virtual machine having a directly assigned physical graphics controller according to some example embodiments. While the example process flow of FIG. 7 is described with respect to a graphics controller, it will be appreciated that the process flow may be applied to other types of physical hardware resources as well. The operations illustrated in and described with respect to FIG. 7 may, for example, be performed by, with the assistance of, and/or under the control of one or more of the processor 110, memory 112, or virtual machine controller 118. Operation 700 may comprise a virtual machine (VM) running with both an assigned physical graphics controller and a corresponding emulated graphics controller. The virtual machine may be using the directly assigned physical graphics controller. At operation 702, the virtual machine may need to be live migrated to another physical machine. Operation 704 may comprise a BIOS of the virtual machine performing a display switch from the directly assigned physical graphics controller to the emulated graphics controller. The display switch of operation 704 may, for example, be performed in accordance with the hot-swap operation discussed with respect to FIG. 4. Operation 706 may comprise the virtual machine stopping use of the directly assigned physical graphics controller, and starting to use the emulated graphics controller attendant to the display switch of operation 704. Operation 708 may comprise the BIOS initiating a hot-remove of the directly assigned physical graphics controller from the virtual machine. The hot-remove of operation 708 may, for example, be performed in accordance with the hot-add operation discussed with respect to FIG. 5. Operation 710 may comprise the virtual machine ejecting the directly assigned physical graphics controller and running on the emulated graphics controller. After the virtual machine is running solely on emulated devices, operation 712 may comprise the virtual machine being live migrated to another physical machine using emulated migration protocols.

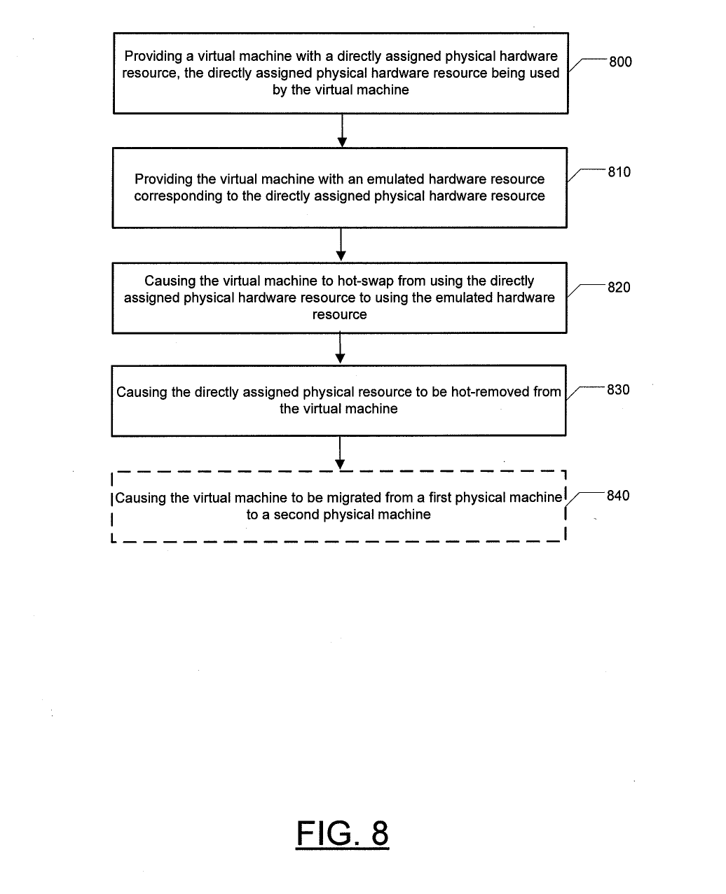

FIG. 8 illustrates a flowchart according to an example method for providing a virtual machine with dynamic direct assignment of a physical hardware resource according to some example embodiments. The operations illustrated in and described with respect to FIG. 8 may, for example, be performed by, with the assistance of, and/or under the control of one or more of the processor 110, memory 112, communication interface 114, user interface 116, or virtual machine controller 118. Operation 800 may comprise providing a virtual machine with a directly assigned physical hardware resource (e.g., a directly assigned physical hardware resource 120). The directly assigned physical hardware resource may be in use by the virtual machine. The processor 110, memory 112, and/or physical hardware resource 120 may, for example, provide means for performing operation 800. Operation 810 may comprise providing the virtual machine with an emulated hardware resource corresponding to the directly assigned physical hardware. The processor 110, memory 112, and/or physical hardware resource 120 may, for example, provide means for performing operation 810. Operation 820 may comprise causing the virtual machine to hot-swap from using the directly assigned physical hardware resource to using the emulated hardware resource. The processor 110, memory 112, and/or physical hardware resource 120 may, for example, provide means for performing operation 820. Operation 830 may comprise causing the directly assigned physical resource to be hot-removed from the virtual machine. The processor 110, memory 112, and/or physical hardware resource 120 may, for example, provide means for performing operation 830. The method may optionally further include operation 840, which may comprise causing the virtual machine to be migrated from a first physical machine to a second physical machine. The processor 110, memory 112, communication interface 114, and/or physical hardware resource 120 may, for example, provide means for performing operation 840.

FIGS. 6-8 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
providing a virtual machine with a directly assigned physical hardware resource, the directly assigned physical hardware resource being used by the virtual machine;
providing the virtual machine with an emulated hardware resource corresponding to the directly assigned physical hardware resource, the emulated hardware resource not being used while the directly assigned physical hardware resource is being used by the virtual machine;
causing, by a processor, the virtual machine to hot-swap from using the directly assigned physical hardware resource to using the emulated hardware resource; and
subsequent to causing the virtual machine to hot-swap to using the emulated hardware resource, causing the directly assigned physical hardware resource to be hot-removed from the virtual machine.

2. The method of claim 1, further comprising:
subsequent to the directly assigned physical hardware resource being hot-removed, causing the virtual machine to be migrated from a first physical machine to a second physical machine.

3. The method of claim 2, further comprising, subsequent to causing the virtual machine to be migrated to the second physical machine:
providing the virtual machine with a second directly assigned physical hardware resource, the second directly assigned physical hardware resource being associated with the second physical machine and corresponding to the emulated hardware resource;
causing the virtual machine to hot-swap from using the emulated hardware resource to using the second directly assigned physical hardware resource.

4. The method of claim 1, further comprising, subsequent to causing the virtual machine to hot-swap to using the emulated hardware resource:
causing the physical hardware resource to be directly assigned to a second virtual machine.

5. The method of claim 1, wherein causing the virtual machine to hot-swap from using the directly assigned physical hardware resource to using the emulated hardware resource comprises controlling a virtual Advanced Configuration and Power Interface (ACPI) implemented on the virtual machine to hot-swap from the directly assigned physical hardware resource to the emulated hardware resource.

6. The method of claim 1, wherein the directly assigned physical hardware resource comprises a physical graphics controller, and wherein the emulated hardware resource comprises an emulated graphics controller.

7. The method of claim 1, wherein the directly assigned physical hardware resource comprises a physical network controller, and wherein the emulated hardware resource comprises an emulated network controller.

8. The method of claim 1, wherein the directly assigned physical hardware resource comprises a physical storage controller, and wherein the emulated hardware resource comprises an emulated storage controller.

9. An apparatus comprising at least one processor and at least one memory storing computer program code, wherein the at least one memory and stored computer program code are configured, with the at least one processor, to cause the apparatus to at least perform:
providing a virtual machine with a directly assigned physical hardware resource, the directly assigned physical hardware resource being used by the virtual machine;
providing the virtual machine with an emulated hardware resource corresponding to the directly assigned physical hardware resource, the emulated hardware resource not being used while the directly assigned physical hardware resource is being used by the virtual machine;
causing the virtual machine to hot-swap from using the directly assigned physical hardware resource to using the emulated hardware resource; and
subsequent to causing the virtual machine to hot-swap to using the emulated hardware resource, causing the directly assigned physical hardware resource to be hot-removed from the virtual machine.

10. The apparatus of claim 9, wherein the at least one memory and stored computer program code are configured, with the at least one processor, to further cause the apparatus to perform:
subsequent to the directly assigned physical hardware resource being hot-removed, causing the virtual machine to be migrated from a first physical machine to a second physical machine.

11. The apparatus of claim 10, wherein the at least one memory and stored computer program code are configured, with the at least one processor, to further cause the apparatus to perform, subsequent to causing the virtual machine to be migrated to the second physical machine:
providing the virtual machine with a second directly assigned physical hardware resource, the second directly assigned physical hardware resource being associated with the second physical machine and corresponding to the emulated hardware resource;
causing the virtual machine to hot-swap from using the emulated hardware resource to using the second directly assigned physical hardware resource.

12. The apparatus of claim 9, wherein the at least one memory and stored computer program code are configured, with the at least one processor, to further cause the apparatus to perform, subsequent to causing the virtual machine to hot-swap to using the emulated hardware resource:
causing the physical hardware resource to be directly assigned to a second virtual machine.

13. The apparatus of claim 9, wherein causing the virtual machine to hot-swap from using the directly assigned physical hardware resource to using the emulated hardware resource comprises controlling a virtual Advanced Configuration and Power Interface (ACPI) implemented on the virtual machine to hot-swap from the directly assigned physical hardware resource to the emulated hardware resource.

14. The apparatus of claim 9, wherein the directly assigned physical hardware resource comprises a physical graphics controller, and wherein the emulated hardware resource comprises an emulated graphics controller.

15. The apparatus of claim 9, wherein the directly assigned physical hardware resource comprises a physical network controller, and wherein the emulated hardware resource comprises an emulated network controller.

16. The apparatus of claim 9, wherein the directly assigned physical hardware resource comprises a physical storage controller, and wherein the emulated hardware resource comprises an emulated storage controller.

17. The apparatus of claim 9, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

18. A computer program product comprising at least one non-transitory computer-readable storage medium having computer-readable program instructions stored therein, the computer-readable program instructions comprising:
program instructions configured to provide a virtual machine with a directly assigned physical hardware resource, the directly assigned physical hardware resource being used by the virtual machine;
program instructions configured to provide the virtual machine with an emulated hardware resource corresponding to the directly assigned physical hardware resource, the emulated hardware resource not being used while the directly assigned physical hardware resource is being used by the virtual machine;
program instructions configured to cause the virtual machine to hot-swap from using the directly assigned physical hardware resource to using the emulated hardware resource; and
program instructions configured, subsequent to causing the virtual machine to hot-swap to using the emulated hardware resource, to cause the directly assigned physical hardware resource to be hot-removed from the virtual machine.

19. The computer program product of claim 18, further comprising:
program instructions configured, subsequent to the directly assigned physical hardware resource being hot-removed, to cause the virtual machine to be migrated from a first physical machine to a second physical machine.

20. The computer program product of claim 18, further comprising:
program instructions configured, subsequent to the directly assigned physical hardware resource being hot-removed, to cause the physical hardware resource to be directly assigned to a second virtual machine.
